(19) United States
(12) Patent Application Publication
(10) Pub. No.: US 2001/0016984 A1
(43) Pub. Date: Aug. 30, 2001

(54) Apparatus for forming restriction in heat exchanger and method for making same

(76) Inventors: Kevin Bennett Wise, Connersville, IL (US); Ramez S. AbdulNour, West Bloomfield, MI (US); Henry Mehraban, Northville, MI (US)

Correspondence Address: Daniel H. Bliss, Bliss McGlynn. P.C., Suite 600, 2075 W. Big Beaver, Troy, MI, 48084, US

(21) Appl. No.: 09/747,722

(22) Filed: Dec. 22, 2000

Related U.S. Application Data
(63) Continuation-in-part of application No. 09/470,383, filed on Dec. 22, 1999.

(51) Int. Cl. B23P 15/26; B21D 53/02

(52) U.S. Cl. 29/890.03; 29/726

(57) ABSTRACT

An apparatus and method for forming a restriction in a plate of a heat exchanger includes a gag extending perpendicularly relative to the plate. The apparatus also includes a servo motor operatively connected to the gag and for connection to a source of power for moving the gag for forming a restriction to fluid flow through either one of a fluid inlet and a fluid outlet of the plate.

### CROSS-REFERENCE TO RELATED APPLICATION(S)

The present application is a Continuation-In-Part of application Ser. No. 09/470,383, filed Dec. 22, 1999.

### BACKGROUND OF THE INVENTION

1. Field of the Invention

The present invention relates generally to heat exchangers and, more specifically, to an apparatus for forming a restriction in a manifold and/or refrigerant plate and method for making same for a heat exchanger in a motor vehicle.

2. Description of the Related Art

It is known to provide plates for a heat exchanger such as an evaporator in a motor vehicle. Typically, opposed plates carry a first fluid medium in contact with an interior thereof while a second fluid medium contacts an exterior thereof. Typically, the first fluid medium is a refrigerant and the second fluid medium is air. Where a temperature difference exists between the first and second fluid mediums, heat will be transferred between the two via heat conductive walls of the plates.

It is also known to provide beaded plates for a heat exchanger in which beads define a plurality of passageways between the plates for movement of a fluid therethrough to increase the surface area of conductive material available for heat transfer and to cause turbulence of the fluid carried in a channel between the plates. An example of such a heat exchanger is disclosed in U.S. Pat. No. 4,600,053. In this patent, each of the plates has a plurality of beads formed thereon with one plate having one distinct variety of beads and the other plate having another distinct variety of beads. The beads of the plates contact each other and are bonded together to force fluid to flow therearound.

Performance of heat exchanger cores such as evaporator cores has been directly linked to refrigerant flow distribution through the core. This includes the flow distribution in a flow header or tank and a tube or plate areas. It is known that an effective way of generating a more uniform flow through the channel is by using a large plenum area upstream of the channel. Therefore, there is a need in the art to enhance the thermal performance in the heat exchanger core through the enhancement of coolant flow distribution inside the core.

The effectiveness of the refrigerant flow distribution through the core is measured by the thermal performance, refrigerant pressure drop, and infrared thermal image of the core skin temperature. Non-uniform distribution of flow starts at the flow header or tank area of the core.

The refrigerant pressure drop inside the core is controlled by several factors: heat transfer from the core to the air; flow restriction inside the core; non-uniform distribution of the refrigerant inside the core; and the change of phase from liquid to vapor because vapor has a higher pressure drop. The pressure drop can increase significantly when any combination or all of these factors are taking place together. Therefore, there is a need in the art to provide a heat exchanger with increased core thermal capacity, minimum increase in refrigerant pressure drop and minimum air temperature non-uniformity.

Therefore, it is desirable to restrict the flow in a back side of a manifold and/or refrigerant plate to improve refrigerant flow distribution inside a heat exchanger. It is also desirable to provide a manifold and/or refrigerant plate for a heat exchanger having a restriction to refrigerant in the heat exchanger. It is further desirable to provide a manifold and/or refrigerant plate having a restriction for a heat exchanger that improves refrigerant flow distribution inside the heat exchanger. It is still further desirable to provide a method of making a manifold and/or refrigerant plate having a restriction for a heat exchanger. It is yet further desirable to provide an apparatus and method for making or forming a restriction in a plate of a heat exchanger.

### SUMMARY OF THE INVENTION

Accordingly, the present invention is an apparatus for forming a restriction in a plate of a heat exchanger. The apparatus includes a gag extending perpendicularly relative to the plate. The apparatus also includes a servo motor operatively connected to the gag and for connection to a source of power for moving the gag for forming a restriction to fluid flow through either one of a fluid inlet and a fluid outlet of the plate.

In addition, the present invention is a method for forming a restriction in a plate of a heat exchanger. The method includes the steps of providing a plate extending longitudinally and providing an apparatus having a gag extending perpendicularly relative to the plate and a servo motor operatively connected to the gag and for connection to a source of power for moving the gag. The method also includes the steps of moving the gag between a retracted position and an extended position by the servo motor and forming a restriction to fluid flow through either one of a fluid inlet or fluid outlet of the plate.

One advantage of the present invention is that a heat exchanger such as an evaporator is provided for use in a motor vehicle. Another advantage of the present invention is that the heat exchanger has a restriction in a back side of a manifold and/or refrigerant plate that is either cross-shaped, round, or multiple apertures. Yet another advantage of the present invention is that the heat exchanger has a restriction that improves the refrigerant flow distribution inside the heat exchanger by restricting the flow in the flow header or tank. Still another advantage of the present invention is that the heat exchanger has improved flow distribution using multiple apertures for a plate-fin heat exchanger such as an evaporator. A further advantage of the present invention is that the heat exchanger improves heat transfer by improving refrigerant flow distribution and enhancing flow mixing inside the flow header or tank. Yet a further advantage of the present invention is that a method of making the heat exchanger is provided with either a cross-shaped, round aperture or multiple aperture restriction in the back side thereof. Still a further advantage of the present invention is that an apparatus is provided for forming the restriction in the heat exchanger.

Other features and advantages of the present invention will be readily appreciated, as the same becomes better understood, after reading the subsequent description taken in conjunction with the accompanying drawings.

### BRIEF DESCRIPTION OF THE DRAWINGS

FIG. 1 is a fragmentary elevational view of a heat exchanger, according to the present invention.

FIG. 2 is a sectional view taken along line 2-2 of FIG. 1.

FIG. 3 is a view similar to FIG. 2 of another embodiment, according to the present invention, of the heat exchanger of FIG. 1.

FIG. 4 is a view similar to FIG. 2 of yet another embodiment, according to the present invention, of the heat exchanger of FIG. 1.

FIG. 5 is a fragmentary elevational view of an apparatus, according to the present invention, for forming a restriction in the heat exchanger of FIGS. 1 through 4 illustrated in a first operational position.

FIG. 6 is a view similar to FIG. 5 of the apparatus illustrated in a second operational position.

FIG. 7 is a view similar to FIG. 5 of the apparatus illustrated in a third operational position.

### DESCRIPTION OF THE PREFERRED EMBODIMENT(S)

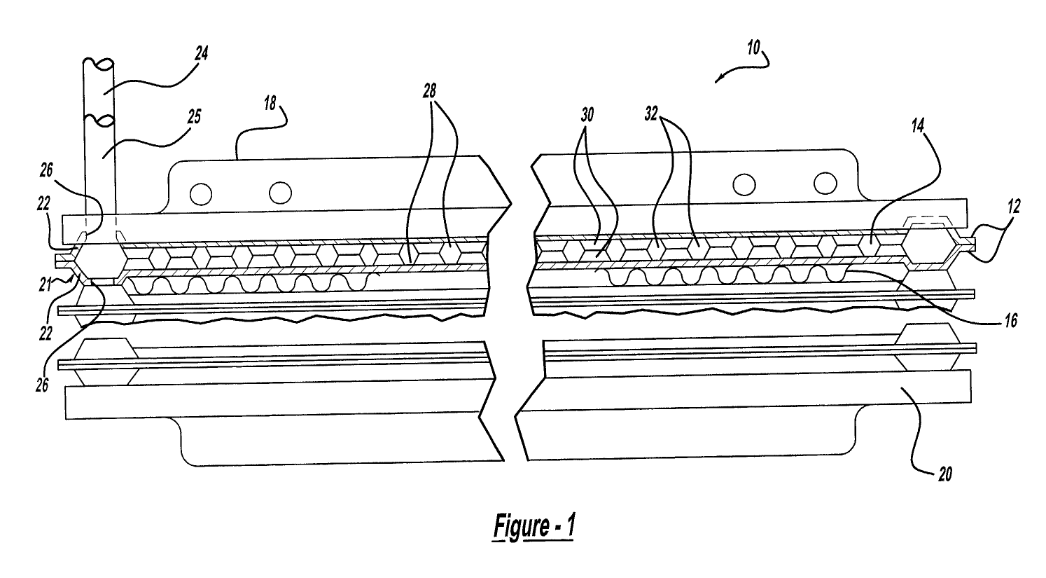

Referring to the drawings and in particular FIG. 1, one embodiment of a heat exchanger 10, according to the present invention, such as an oil cooler, evaporator, or condenser, is shown for a motor vehicle (not shown). The heat exchanger 10 includes a plurality of generally parallel beaded plates 12, pairs of which are joined together in a face-to-face relationship to provide a channel 14 therebetween. The heat exchanger 10 also includes a plurality of convoluted or serpentine fins 16 attached an exterior of each of the beaded plates 12. The fins 16 are disposed between each pair of the joined beaded plates 12 to form a stack. The fins 16 serve as a means for conducting heat away from the beaded plates 12 while providing additional surface area for convective heat transfer by air flowing over the heat exchanger 10. The heat exchanger 10 further includes oppositely disposed first and second manifolds 18 and 20 at ends of the stack. The manifolds 18, 20 fluidly communicate with flow headers, generally indicated at 21, formed by bosses 22 on each of the beaded plates 12. The heat exchanger 10 includes a fluid inlet tube 24 for conducting fluid into the heat exchanger 10 formed in the first manifold 18 and a fluid outlet tube 25 for directing fluid out of the heat exchanger 10 formed in the first manifold 18. It should be appreciated that, except for the manifold 18, the heat exchanger 10 is conventional and known in the art. It should also be appreciated that the manifold 18 could be used for heat exchangers in other applications besides motor vehicles.

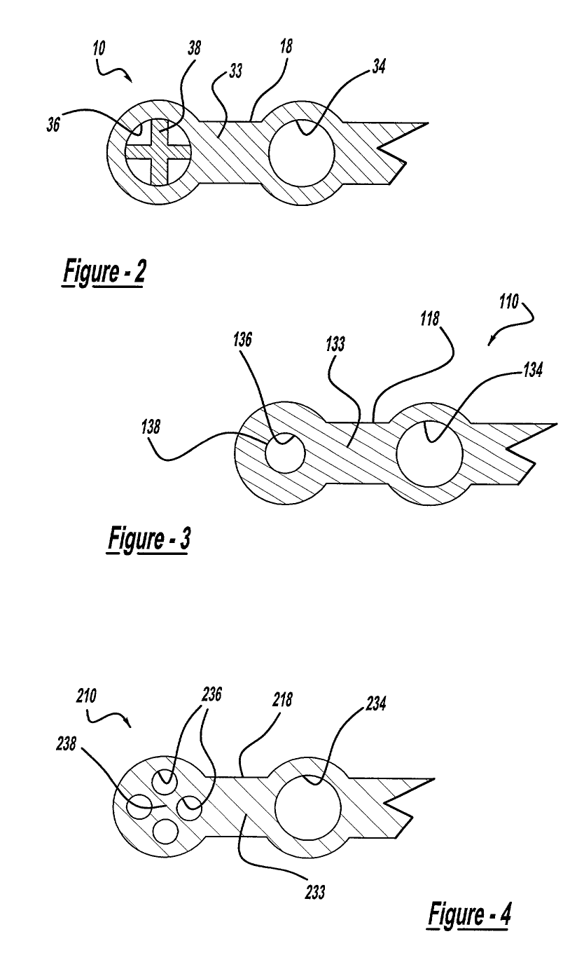

Referring to FIGS. 1 and 2, the beaded plate 12, according to the present invention, extends longitudinally and is substantially planar or flat. The beaded plate 12 includes a raised boss 22 on at least one end having at least one aperture 26 extending therethrough. The apertures 26 form an inlet (not shown) and an outlet (not shown) spaced transversely and divided by a wall (not shown). The bosses 22 are stacked together such that the apertures 26 are aligned to form the flow header 21 to allow parallel flow of fluid through the channels 14 of the beaded plates 12. It should be appreciated that such flow headers 21 are conventional and known in the art.

The beaded plate 12 includes a surface 28 being generally planar and extending longitudinally and laterally. The beaded plate 12 also includes a plurality of beads 30 extending above and generally perpendicular to a plane of the surface 28 and spaced laterally from each other. The beads 30 are generally circular in shape and have a predetermined diameter such as three millimeters. The beads 30 have a predetermined height such as 1.5 millimeters. It should be appreciated that the beads 30 may have a generally frusto-conical cross-sectional shape. It should also be appreciated that the beads 30 are formed in a plurality of rows, which are repeated, with each row containing a plurality of, preferably a predetermined number of beads 30 in a range of two to eleven.

The beaded plate 12 is made of a metal material such as aluminum or an alloy thereof and has a cladding on its inner and outer surfaces for brazing. In the embodiment illustrated, a pair of the beaded plates 12 are arranged such that the beads 30 contact each other to form a plurality of flow passages 32 in the channel 14 as illustrated in FIG. 1. The beads 30 turbulate fluid flow through the channel 14. It should be appreciated that the beads 30 are brazed to each other. It should also be appreciated that the entire heat exchanger 10 is brazed together as is known in the art.

Referring to FIGS. 1 and 2, the manifold 18, according to the present invention, has a plate 33 extending longitudinally and a first aperture 34 and a second aperture 36 spaced laterally and extending through the plate 33. The first aperture 34 forms a fluid inlet and communicates with the fluid inlet tube 24. The second aperture 36 forms a fluid outlet and communicates with the fluid outlet tube 25. The first aperture 34 and second aperture 36 have approximately the same diameter. The manifold 18 also includes a restriction 38 in the fluid outlet to distribute the refrigerant flow more uniformly inside the flow header 21 for the heat exchanger 10. The restriction 38 is formed as a cross-shaped or plus-shaped member disposed in the second aperture 36 forming the fluid outlet as illustrated in FIG. 2. The restriction 38 improves the core performance of the heat exchanger 10 significantly with more uniform flow distribution of the refrigerant in the flow header area. The size of the restriction 38 is a function of the non-dimensional quantity:

$$\frac{\begin{matrix}( Manifold Hydraulic Area without Restriction \text{-} \\ Manifold Hydraulic Area with Restriction )\end{matrix}}{\begin{matrix}Manifold Hydraulic Area \\ without Restriction \times 100\end{matrix}}$$

It should be appreciated that the restriction 38 can be formed in the aperture 26 of the beaded plate 12. It should also be appreciated that the restriction 38 can be formed in either the fluid inlet or fluid outlet of the beaded plate 12 and/or manifold 18. It should further be appreciated that the restriction 38 is variable by modifying the restriction where desired for the beaded plates 12 and/or manifold 18 to even flow through the heat exchanger 10. It should still further be appreciated that the restriction 38 can be applied to both single and dual tank evaporator type heat exchangers.

Referring to FIG. 3, another embodiment 110, according to the present invention, of the heat exchanger 10 is shown. Like parts of the heat exchanger 10 have like reference numerals increased by one hundred (100). In this embodiment, the heat exchanger 110 includes the manifold 118 having the plate 133 extending longitudinally and a first aperture 134 and a second aperture 136 spaced laterally and extending through the plate 133. The first aperture 134 forms a fluid inlet and communicates with the fluid inlet tube 24. The second aperture 136 forms a fluid outlet and communicates with the fluid outlet tube 25. The manifold 118 also includes a restriction 138 in the fluid outlet to distribute the refrigerant flow more uniformly inside the flow header 121 for the heat exchanger 110. In this embodiment, the restriction 138 is formed as the second aperture 136 having a circular cross-sectional shape and a diameter less than a diameter of the first aperture 134 as illustrated in FIG. 3. The restriction 138 improves the core performance of the heat exchanger 110 significantly with more uniform flow distribution of the refrigerant in the flow header area. The size of the restriction 138 is a function of the non-dimensional quantity:

$$\frac{\begin{matrix}Manifold Hydraulic Area without Restriction \text{-} \\ Manifold Hydraulic Area with Restriction\end{matrix}}{\begin{matrix}Manifold Hydraulic Area \\ without Restriction \times 100\end{matrix}}$$

It should be appreciated that the restriction 138 can be formed in the aperture 26 of the beaded plate 12. It should also be appreciated that the restriction 138 can be formed in either the fluid inlet or fluid outlet of the beaded plate 12 and/or manifold 118. It should further be appreciated that the restriction 138 can be applied to both single and dual tank evaporator type heat exchangers.

Referring to FIG. 4, yet another embodiment 210, according to the present invention, of the heat exchanger 10 is shown. Like parts of the heat exchanger 10 have like reference numerals increased by two hundred (200). In this embodiment, the heat exchanger 210 includes the manifold 218 having a plate 233 extending longitudinally and a first aperture 234 and a second aperture 236 spaced laterally and extending through the plate 233. The first aperture 234 forms a fluid inlet and communicates with the fluid inlet tube 24. The second aperture 236 forms a fluid outlet and communicates with the fluid outlet tube 25. The manifold 218 also includes a restriction 238 in the fluid outlet to distribute the refrigerant flow more uniformly inside the flow header 21 for the heat exchanger 210. In this embodiment, the restriction 238 is formed as a plurality of second apertures 236 having a circular cross-sectional shape and a diameter less than a diameter of the first aperture 234. Preferably, the diameter of the second apertures 236 is approximately two millimeters to approximately five millimeters. Preferably, the radial distance between opposed second apertures 236 is approximately two millimeters to approximately eight millimeters as illustrated in FIG. 4. The restriction 238 improves the core performance of the heat exchanger 210 significantly with more uniform flow distribution of the refrigerant in the flow header area. It should be appreciated that the restriction 238 can be formed in the aperture 26 of the beaded plate 12. It should also be appreciated that the restriction 238 can be formed in either the fluid inlet or fluid outlet of the beaded plate 12 and/or manifold 218. It should further be appreciated that the restriction 238 can be applied to both single and dual tank evaporator type heat exchangers.

Additionally, a method of making the heat exchanger 10, 110, 210, according to the present invention, is disclosed. The method includes the step of providing a plate 33, 133, 233, 12 extending longitudinally. The method includes the step of forming a first aperture 34, 134, 234, 26, 126, 226 extending through the plate 33, 133, 233, 12 as a fluid inlet and at least one second aperture 36, 136, 236, 26 spaced laterally from the first aperture 34, 134, 234, 26, 126, 226 and extending through the plate 33, 133, 233, 12 as a fluid outlet. The method also includes the steps of forming a restriction 38, 138, 238 in either one of the fluid inlet or fluid outlet. The step of forming is carried out by punching the apertures 34, 134, 234, 26, 126, 226 and restriction 38, 138, 238 in the plate 33, 133, 233, 12 by conventional punching processes. It should be appreciated that the size of the apertures 34, 134, 234, 26, 126, 226 could be such that they are relatively small, then progressively get bigger traveling down a length of the stacked beaded plates 12.

Also, a method of making the heat exchanger 10, according to the present invention, is shown. The method includes the step of contacting first and second beaded plates 12 with each other to form the channel 14 therebetween and contact opposed beads 30 with each other to form the fluid flow passages 32 as illustrated in FIG. 1. The method includes the step of brazing a pair of the beaded plates 12 by heating the beaded plates 12 to a predetermined temperature to melt the brazing material to braze the bosses 22 and the beads 30 of the beaded plates 12 together. The pair of joined beaded plates 12 is then cooled to solidify the molten braze material to secure the bosses 22 together and the beads 30 together. The method includes the step of disposing the fins 16 between joined pairs of the beaded plates 12 and brazing the fins 16 and beaded plates 12 together. The method includes the steps of connecting the first and second manifolds 18 and 20 to the brazed fins 16 and beaded plates 12 and brazing them together to form the heat exchanger 10.

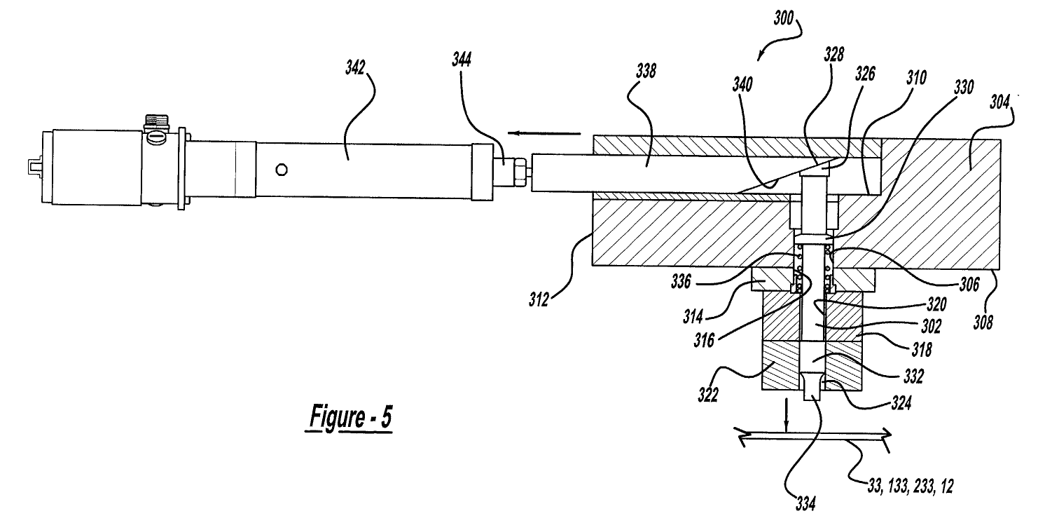

Referring to FIGS. 5 through 7, an apparatus 300, according to the present invention, is shown for forming the apertures 34, 134, 234, 26, 126, 226 and restriction 38, 138, 238 in the plate 33, 133, 233, 12. The apparatus 300 includes at least one, preferably a plurality of gags 302 to control the inlet/outlet restriction 38, 138, 238. Each gag 302 is moved in or out depending on the desired size of the restriction 38, 138, 238. It should be appreciated that this process lends itself very well to a continuous plate fin heat exchanger, such as a continuous corrugated evaporator.

The apparatus 300 includes a housing 304 to support the gag 302. The housing 304 is generally rectangular in shape and has an aperture 306 extending longitudinally therein from a bottom surface 308 thereof. The aperture 306 has a generally circular cross-sectional shape. The housing 304 also has a cavity 310 extending transversely therein from a side surface 312 thereof and communicating with the aperture 306. The housing 304 is made of a metal material. It should be appreciated that the cavity 310 extends generally perpendicular to the aperture 306.

The apparatus 300 also includes a support plate 314 connected to the bottom surface 308 of the housing 304 by suitable means such as welding. The support plate 314 is generally rectangular in shape and of a size less than the housing 304. The support plate 314 has an aperture 316 extending longitudinally therethrough to receive the gag 302. The aperture 316 has a generally circular cross-sectional shape. The apparatus 300 includes a first guide block 318 connected to the support plate 314 by suitable means such as welding. The first guide block 318 is generally rectangular in shape and of a size less than the support plate 314. The first guide block 318 has an aperture 320 extending longitudinally therethrough to receive the gag 302. The aperture 320 has a generally circular cross-sectional shape. The apparatus 300 also includes a second guide block 322 connected to the first guide block 318 by suitable means such as welding. The second guide block 322 is generally rectangular in shape and of a size similar to the first guide block 318. The second guide block 322 has an aperture 324 extending longitudinally therethrough to receive the gag 302. The aperture 324 has a generally circular cross-sectional flange. The support plate 314, first guide block 318, and second guide block 322 are made of a metal material.

The gag 302 is generally cylindrical in shape with a generally circular cross-section. The gag 302 has a punch driver or head 326 at one end which is disposed in the cavity 310 of the housing 304. The head 326 has an angled or inclined head surface 328 for a function to be described. The gag 302 also has a flange 330 extending radially outwardly and circumferentially and spaced axially from the head 326. The flange 330 is disposed in the aperture 306 of the housing 304 for a function to be described. The gag 302 has a form punch 332 extending axially and radially from the end opposite the head 326. The form punch 332 has a reduced diameter punch portion 334 extending axially to form the apertures 34, 134, 234, 26, 126, 226 and restriction 38, 138, 238 in the plate 33, 133, 233, 12. The gag 302 is made of a metal material. It should be appreciated that the gag 302 may be integral, unitary, and one-piece.

The apparatus 300 also includes a spring 336 disposed about the gag 302 to provide upward pressure against the gag 302 to hold the form punch 332 in a desired position. The spring 336 is of a coil type and is disposed about the gag 302 between the flange 330 and the first guide block 318. It should be appreciated that the gag 302 may reciprocate or move linearly in the apertures 306, 316, 320, 324 of the housing 304, support plate 314, first guide block 318, and second guide block 322, respectively.

The apparatus 300 further includes a movable gag slide 338 disposed partially in the cavity 310 of the housing 304 for sliding movement therein. The gag slide 338 is generally rectangular in shape. The gag slide 338 has an end surface 340 at one end which is angled or inclined for cooperating with the inclined head surface 328 of the head 326. It should be appreciated that the sliding movement of the gag slide 338 moves the gag 302 up and down via the inclined surfaces 340 and 328.

The apparatus 300 includes a linear or rotary servo motor 342 connected to the other end of the gag slide 338 opposite the end surface 340. The servo motor 342 includes a ballscrew 344 connected to the gag slide 338 to move the gag slide 338 linearly relative to the housing 304. It should be appreciated that the servo motor 342 is connected to a source of power (not shown). It should also be appreciated that the servo motor 342 is conventional and known in the art.

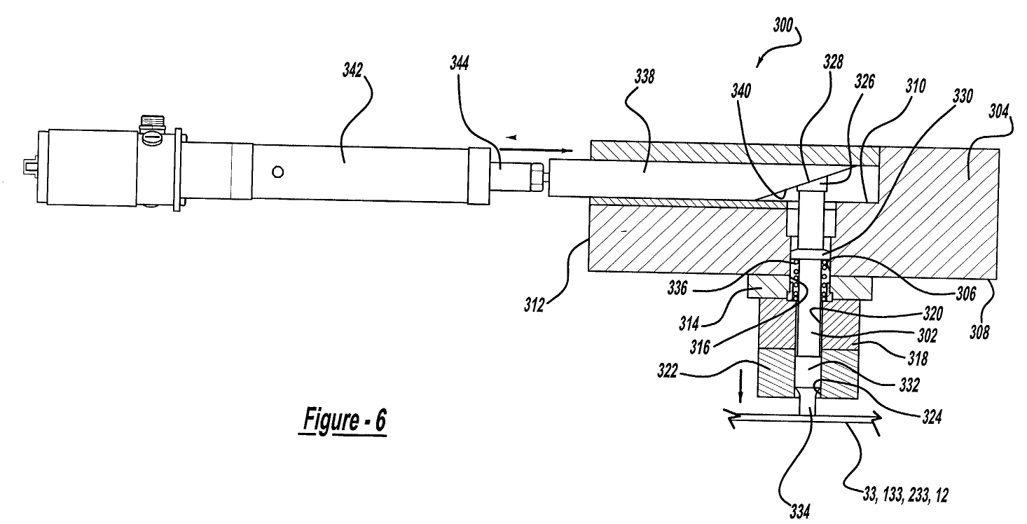

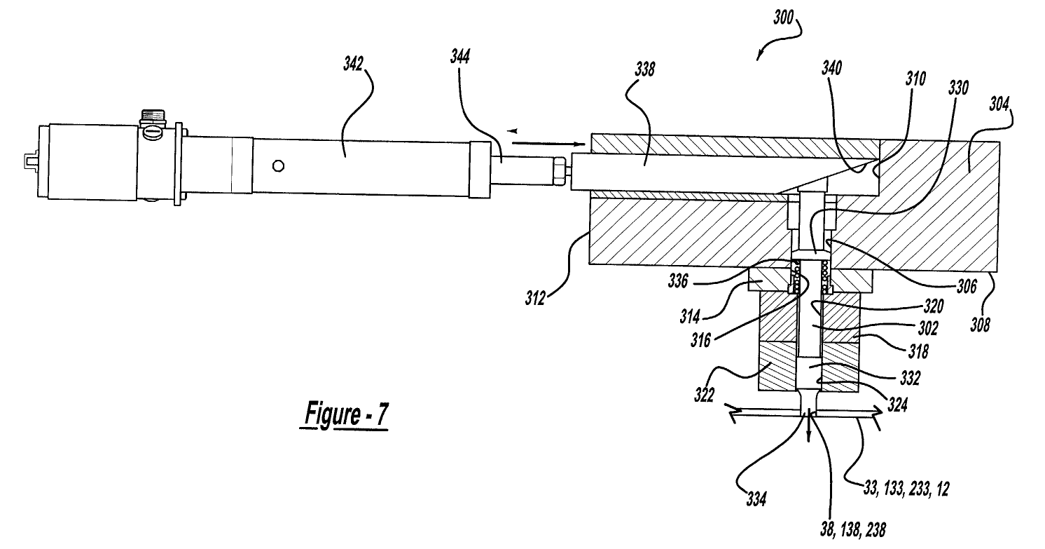

In operation of the apparatus 300, the servo motor 342 has the ballscrew 344 in a retracted position as illustrated in FIG. 5. In this position, the gag 302 is also in a retracted position such that the form punch 334 is spaced from the plate 33, 133, 233, 12. The servo motor 342 moves or extends the ballscrew 344, which, in turn, extends the gag slide 338 into the cavity 310 of the housing 304. Opposing angles of the surfaces 340 and 328 on the gag slide 338 and head 326, respectively, allow the form punch 334 to be forced downward as the servo motor 342 is extended pushing the gag slide 338 into the gag 302 as illustrated in FIG. 6. The servo motor 342 moves the ballscrew 344 to a fully extended position as illustrated in FIG. 7. In this position, the form punch 344 punches the plate 33, 133, 233, 12 to form the apertures 34, 134, 234, 26, 126, 226 and restriction 38, 138, 238 in the plate 33, 133, 233, 12. The operation is reversed, the plate 33, 133, 233, 12 is moved, and the operation is repeated. It should be appreciated that precise movements of the servo motor 342 with the ballscrew 344 driving the gag slide 338 allows precise adjustability of travel in the up or down movement of objects. It should also be appreciated that this configuration will allow not only full in and out movements but may be programmed for precise increments between fully retracted and fully extended positions.

The present invention has been described in an illustrative manner. It is to be understood that the terminology, which has been used, is intended to be in the nature of words of description rather than of limitation.

Many modifications and variations of the present invention are possible in light of the above teachings. Therefore, within the scope of the appended claims, the present invention may be practiced other than as specifically described.

What is claimed is:

1. An apparatus for forming a restriction in a plate of a heat exchanger comprising:
a gag extending perpendicularly relative to the plate; and
a servo motor operatively connected to said gag and for connection to a source of power for moving said gag for forming a restriction to fluid flow through either one of a fluid inlet and a fluid outlet of the plate.

2. An apparatus as set forth in claim 1 wherein said servo motor includes a movable ballscrew for movement between a retracted position and an extended position.

3. An apparatus as set forth in claim 2 including a gag slide connected to said ballscrew and extending perpendicular to said gag for cooperating with said gag.

4. An apparatus as set forth in claim 3 wherein said gag slide has an end surface being inclined and said gag has a head with a surface being inclined to cooperate with said end surface to move said gag up and down as said gag slide is retracted and extended.

5. An apparatus as set forth in claim 1 including a housing having a first aperture extending therein, said gag being disposed partially in said first aperture.

6. An apparatus as set forth in claim 5 including a spring for applying pressure against said gag to retract said gag within said housing.

7. An apparatus as set forth in claim 5 including a support plate connected to said housing and having a second aperture extending therethrough, said gag extending through said second aperture.

8. An apparatus as set forth in claim 7 including a first guide block connected to said support plate having a third aperture extending therein, said gag extending through said third aperture.

9. An apparatus as set forth in claim 8 including a second guide block connected to said first guide block having a fourth aperture extending therein, said gag being disposed partially in said fourth aperture.

10. An apparatus as set forth in claim 1 wherein said gag has a form punch at one end thereof for contacting the plate.

11. An apparatus for forming a restriction in a plate of a heat exchanger comprising:
a gag extending perpendicularly relative to the plate;
a gag slide extending perpendicular to said gag for cooperating with said gag; and
a servo motor including a movable ballscrew connected to said gag slide and for connection to a source of power for moving said gag slide and said gag between a retracted position and an extended position for forming a restriction to fluid flow through either one of a fluid inlet and a fluid outlet of the plate.

12. An apparatus as set forth in claim 11 including a housing having a first aperture extending therein, said gag being disposed partially in said first aperture.

13. An apparatus as set forth in claim 12 including a spring for applying pressure against said gag to retract said gag within said housing.

14. An apparatus as set forth in claim 12 including a support plate connected to said housing and having a second aperture extending therethrough, a first guide block connected to said support plate having a third aperture extending therethrough, and a second guide block connected to said first guide block having a fourth aperture extending therethrough, said gag extending through said second aperture, said third aperture, and said fourth aperture.

15. An apparatus as set forth in claim 11 wherein said gag slide has an end surface being inclined and said gag has a head with a surface being inclined to cooperate with said end surface to move said gag up and down as said gag slide is retracted and extended.

16. A method for forming a restriction in a plate of a heat exchanger comprising the steps of:
providing a plate extending longitudinally;
providing an apparatus having a gag extending perpendicularly relative to the plate and a servo motor operatively connected to the gag and for connection to a source of power for moving the gag;
moving the gag between a retracted position and an extended position by the servo motor; and
forming a restriction to fluid flow through either one of a fluid inlet or fluid outlet of the plate.

17. A method as set forth in claim 16 wherein said step of forming comprises forming a plus-shaped member in one of the apertures forming either one of the fluid inlet or fluid outlet.

18. A method as set forth in claim 16 wherein said step of forming comprises forming one of the apertures forming either one of the fluid inlet or the fluid outlet with a diameter less than the other one of the fluid inlet or the fluid outlet.

19. A method as set forth in claim 16 wherein said step of forming comprises forming one of the apertures forming either one of the fluid inlet or the fluid outlet with a generally circular cross-sectional shape.

20. A method as set forth in claim 16 wherein said step of forming comprises forming either one of the fluid inlet or the fluid outlet from a plurality of the apertures having a diameter less than the aperture forming the other one of the fluid inlet or fluid outlet.
